(19) United States
(12) Patent Application Publication
(10) Pub. No.: US 2020/0127875 A1
(43) Pub. Date: Apr. 23, 2020

(54) Reference Signal With Low Power Imbalance And Low Peak-To-Average Power Ratio In Mobile Communications

(71) Applicant: MediaTek Inc., Hsinchu City (TW)

(72) Inventors: Weidong Yang, San Diego, CA (US); Tzu-Han Chou, San Jose, CA (US); Chao-Cheng Su, Hsinchu City (TW)

(21) Appl. No.: 16/576,767

(22) Filed: Sep. 20, 2019

Related U.S. Application Data
(60) Provisional application No. 62/738,004, filed on Sep. 28, 2018.
(60) Provisional application No. 62/754,665, filed on Nov. 2, 2018.

(51) Int. Cl. H04L 25/02; H04L 5/00; H04L 27/26; H04J 13/18; H04B 7/06; H04L 27/34

(52) U.S. Cl. CPC H04L 25/0224; H04L 5/0023; H04L 5/0048; H04L 27/2613; H04L 27/2614; H04J 13/18; H04B 7/0626; H04L 27/3411; H04L 5/0026

(57) ABSTRACT

Various examples and schemes pertaining to reference signals with low power imbalance and low peak-to-average power ratio (PAPR) in mobile communications are described. A processor of an apparatus generates a multi-port multi-symbol reference signal (RS). The processor then controls a transmitter to transmit the multi-port multi-symbol RS through a plurality of antenna ports. In generating the multi-port multi-symbol RS, the processor performs either or both of: (1) modifying a time-domain orthogonal cover code (TD-OCC) pattern for code-division multiplexing (CDM) with respect to the multi-port multi-symbol RS such that time-domain power imbalance is reduced; and (2) performing a permutation on a respective sequence of each CDM group of a plurality of CDM groups with respect to the multi-port multi-symbol RS such that a peak-to-average power ratio (PAPR) is reduced.

### CROSS REFERENCE TO RELATED PATENT APPLICATION(S)

The present disclosure is part of a non-provisional application claiming the priority benefit of U.S. Patent Application Nos. 62/738,004 and 62/754,665, filed on 28 Sep. 2018 and 2 Nov. 2018, respectively, the content of which being incorporated by reference in its entirety.

### TECHNICAL FIELD

The present disclosure is generally related to mobile communications and, more particularly, to reference signals with low power imbalance and low peak-to-average power ratio (PAPR) in mobile communications.

### BACKGROUND

Unless otherwise indicated herein, approaches described in this section are not prior art to the claims listed below and are not admitted as prior art by inclusion in this section.

The release 15 (Rel-15) of the 3^{rd} Generation Partnership Project (3GPP) specification for New Radio (NR) notes a power imbalance issue which may arise when a spatial linear precoder is applied to demodulation reference signal (DMRS) ports in the same code-division multiplexing (CDM) group that are obtained through the use of orthogonal cover code (OCC) pattern w_{f}(k′)·wₜ(1′). The combined effect of spatial linear precoder and the OCC pattern leads to signal nulls at some fixed resource element (RE) locations in a physical resource block (PRB) where the DMRS ports reside. As a result, signal nulls at all RE locations in some orthogonal frequency-division multiplexing (OFDM) symbols may result. Additionally, a DMRS as specified in Rel-15 can have high PAPR issue, which can be caused by summing the same sequence (up to a phase rotation) allocated to different CDM groups. Therefore, there is a need to address these issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

In one aspect, a method may involve a processor of an apparatus generating a multi-port multi-symbol reference signal (RS). The method may also involve the processor controlling a transmitter to transmit the multi-port multi-symbol RS through a plurality of antenna ports. In generating the multi-port multi-symbol RS, the method may involve the processor modifying a time-domain orthogonal cover code (TD-OCC) pattern for code-division multiplexing (CDM) with respect to the multi-port multi-symbol RS such that time-domain power imbalance is reduced.

In one aspect, a method may involve a processor of an apparatus generating a multi-port multi-symbol reference signal (RS). The method may also involve the processor controlling a transmitter to transmit the multi-port multi-symbol RS through a plurality of antenna ports. In generating the multi-port multi-symbol RS, the method may involve the processor performing a permutation on a respective sequence of each CDM group of a plurality of CDM groups with respect to the multi-port multi-symbol RS such that a PAPR is reduced.

In one aspect, a method may involve a processor of an apparatus generating a multi-port multi-symbol reference signal (RS). The method may also involve the processor controlling a transmitter to transmit the multi-port multi-symbol RS through a plurality of antenna ports. In generating the multi-port multi-symbol RS, the method may involve the processor performing either or both of: (1) modifying a TD-OCC pattern for CDM with respect to the multi-port multi-symbol RS such that time-domain power imbalance is reduced; and (2) performing a permutation on a respective sequence of each CDM group of a plurality of CDM groups with respect to the multi-port multi-symbol RS such that a PAPR is reduced.

It is noteworthy that, although description provided herein may be in the context of certain radio access technologies, networks and network topologies such as 5th Generation (5G) and NR, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet of Things (IoT), narrowband IoT (NB-IoT), and any future-developed networks and technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario in accordance with an implementation of the present disclosure.

FIG. 2 is a diagram of an example scenario in accordance with an implementation of the present disclosure.

FIG. 3 is a diagram of an example scenario in accordance with an implementation of the present disclosure.

FIG. 4 is a block diagram of an example communication environment in accordance with an implementation of the present disclosure.

FIG. 5 is a flowchart of an example process in accordance with an implementation of the present disclosure.

FIG. 6 is a flowchart of an example process in accordance with an implementation of the present disclosure.

FIG. 7 is a flowchart of an example process in accordance with an implementation of the present disclosure.

FIG. 8 is a diagram of an example scenario of power imbalance of Rel-15 DMRS.

FIG. 9 is a diagram of an example scenario of power imbalance of DMRS ports.

FIG. 10 is a diagram of an example scenario of frequency domain with high PAPR.

FIG. 11 is a diagram of |f_{d,D} (n)| with some value pairs (d, D) of high PAPR.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to reference signals with low power imbalance and low PAPR in mobile communications. According to the present disclosure, a number of possible solutions may be implemented separately or jointly. That is, although these possible solutions may be described below separately, two or more of these possible solutions may be implemented in one combination or another. It is noteworthy that, although description herein may be in the context of DMRS, the same may also apply to channel state information reference signal (CSI-RS). In other words, the various proposed schemes described herein may be applicable to both DMRS and CSI-RS.

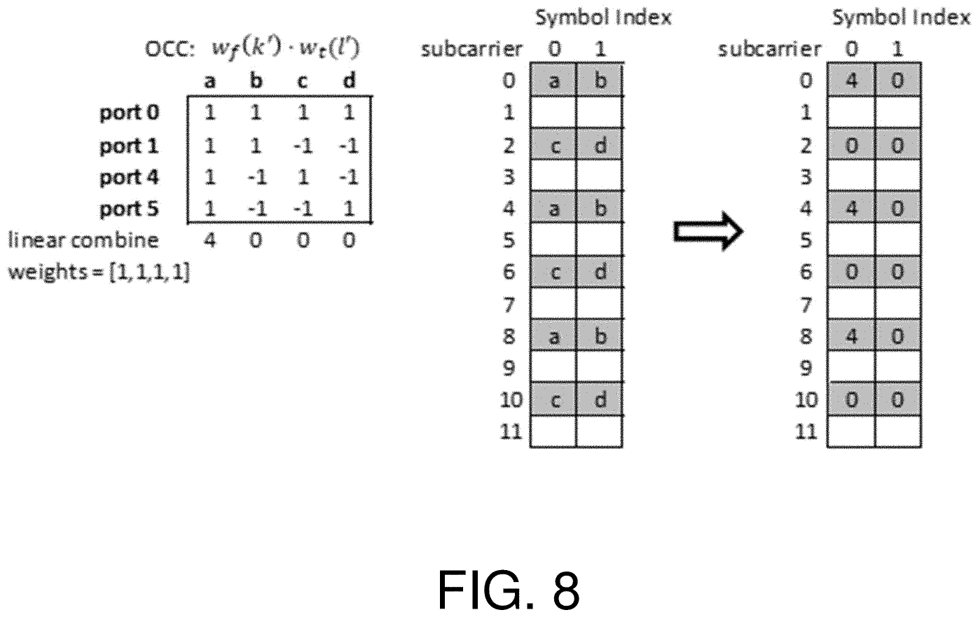

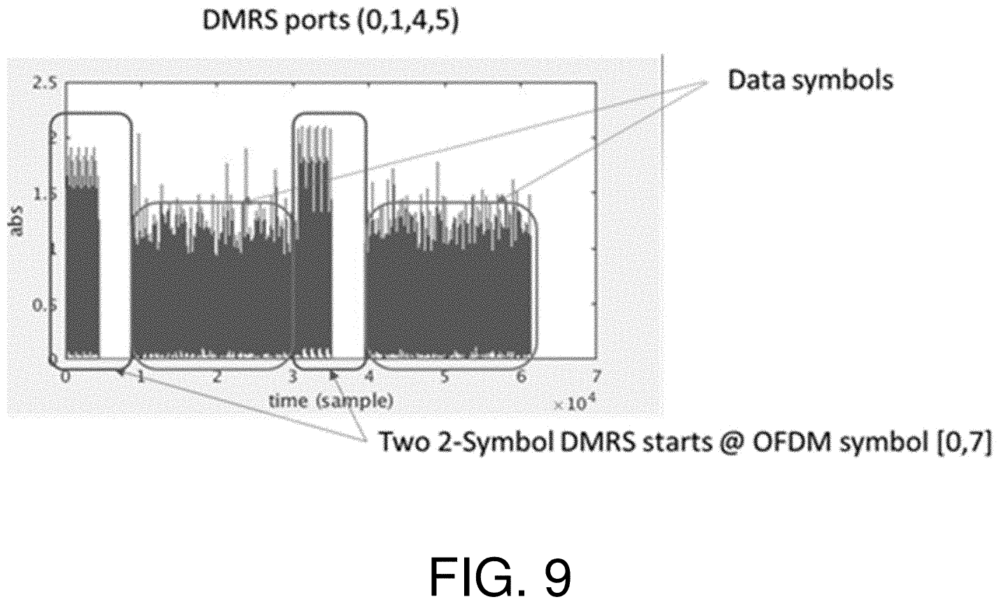

Regarding the power imbalance issue, take a four-port two-symbol Type 1 DMRS as an example, FIG. 8 shows a problematic case when all ports are weighted by a spatial linear precoder [1,1,1,1], with {a,b,c,d} indicating the fixed RE locations spanned by OCCs. The second OFDM symbol has zero power while the first symbol has twice the power compared with regular data symbols. The power imbalance in time decreases the efficiency of the power amplifier (PA), as shown in FIG. 9.

With respect to the linear combination of DMRS ports, power of non-zero RE in the first symbol has four times power compared with uniformly distributed power in frequency domain. Given that DMRS can have power boost (up to 3 dB for Type 1 and 4.77 dB for Type 2), as a result, there can be 9 dB (for Type 1) power difference between some DMRS REs and data REs. Moreover, a regular on-off pattern (peak in every other four REs) is shown in the frequency domain. When considering non-linearity of PA, a pattern of evenly spaced high-power REs could cause higher variation for out-of-band (OOB) spectrum emission.

It may be plausible that this issue can be resolved by applying a phase shift (possibly random) to each scheduled port and corresponding data layer. Such scheme could be useful for multi-user multi-input and multi-output (MU-MIMO) rank 1 transmission. However, for single-user MIMO (SU-MIMO) with a higher rank, additional phase on each layer could compromise the phase selected from the precoding matrix indicator (PMI), which is derived from CSI-RS and/or sounding reference signal (SRS), thereby degrading MIMO performance.

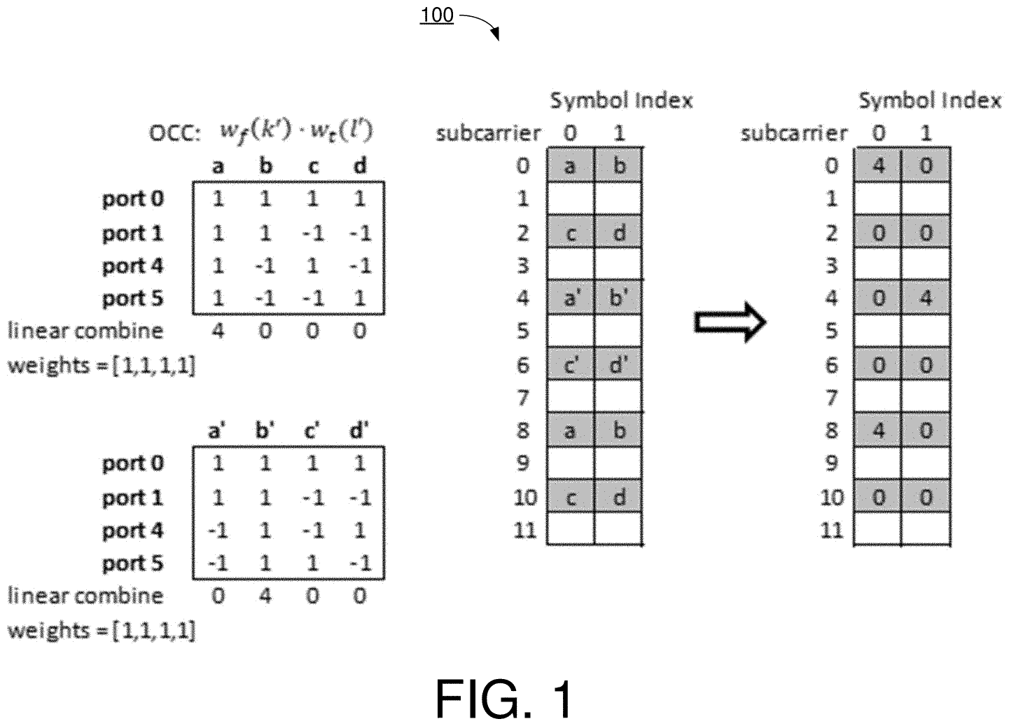

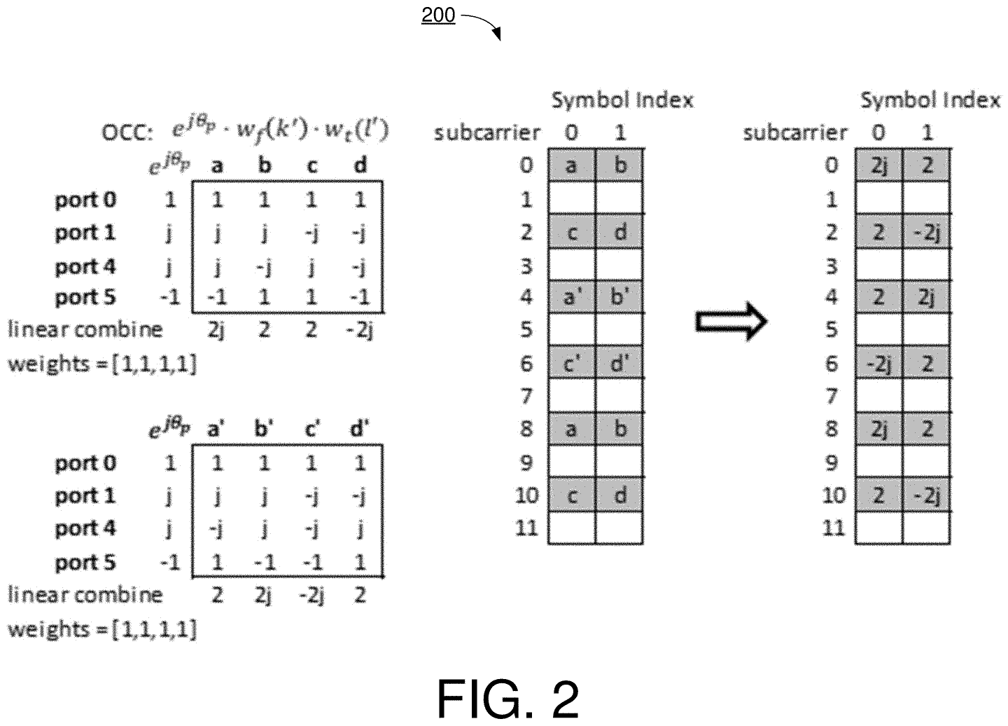

In view of the above, the present disclosure aims to address the power imbalance issue with some proposed schemes, as described below. FIG. 1 illustrates an example scenario 100 in accordance with an implementation of the present disclosure. FIG. 2 illustrates an example scenario 200 in accordance with an implementation of the present disclosure. The following description of proposed schemes with respect to the power imbalance issue is provided with reference to FIG. 1 and FIG. 2.

In one proposed scheme in accordance with the present disclosure, circular shifted TD-OCC may be applied along frequency domain alternatively. For instance, in an event that TD-OCC has a length of 2, application of this proposed scheme may be equivalent to alternative reversed TD-OCC while circular shifted TD-OCC may be easily extended to cases with larger TD-OCC lengths (e.g., in CSI-RS). As a result, {a,b,c,d} and {a′,b′,c′,d′} patterns may alternatively appear in frequency domain as shown in FIG. 1. As can be seen in FIG. 1, when there are even number of PRBs, two DMRS symbols may have the same power.

One advantage of this proposed scheme may be that the power of two symbols may be balanced regardless of spatial precoding weights. On the other hand, one disadvantage of this proposed scheme may be that it may have regular on-off power patterns in the frequency domain. As in the four-port DMRS case shown in FIG. 1, power distribution in the frequency domain is even less uniform than the original waveform in FIG. 8.

In another proposed scheme in accordance with the present disclosure, port-specific phase rotation may be applied to existing OCC. More specifically, the OCC for DMRS port p may be defined as e^{jθ}^{ₚ}·w_{f}(k′)·wₜ(l′). The orthogonality between OCCs may remain unchanged after a constant phase shift e^{jθ}^{ₚ}. An example is shown in FIG. 2.

For simplicity of design, phase e^{jθ}^{ₚ} may take value from the set {1, −1, j, −j}. To determine a specific sequence [e^{jθ}^{₀}, e^{jθ}^{₁}, e^{jθ}^{₄}, e^{jθ}^{₅}], some possible DMRS port combinations may be as those shown in Table 1 below, according to 3GPP Technical Specification (TS) 38.212, with possible precoding weight (e.g., uplink codebook from TS 38.211) for all transmitting antennas.

TABLE 1
DMR Port Combinations

| Number of Ports | Port Combination |
|---|---|
| 2 ports | {0, 1}, {4, 5}, {0, 4} |
| 3 ports | {0, 1, 4} |
| 4 ports | {0, 1, 4, 5} |

Table 2 below lists some candidates of [e^{jθ}^{₀}, e^{jθ}^{₁}, e^{jθ}^{₄}, e^{jθ}^{₅}], which may be found to have uniform power when four ports are configured.

TABLE 2
Candidate Phase Vectors
[e^{jθ}^{₀}, e^{jθ}^{₁}, e^{jθ}^{₄}, e^{jθ}^{₅}]
[1, j, j, −1]
[1, j, −j, 1]
[1, −j, j, 1]
[1, −j, −j, 1]

Furthermore, this proposed scheme may combine with the above-described proposed scheme of circular shifted TD-OCC to achieve balanced power in time regardless of precoding weights as well as have uniform power in frequency domain. An example of a combination of both proposed schemes of port-specific phase rotation on OCC and circular shifted TD-OCC being applied is shown in FIG. 2.

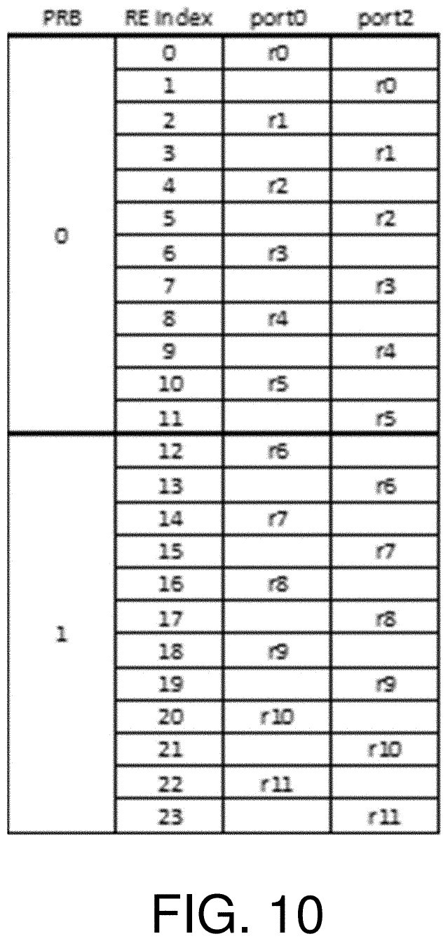

Regarding the high PAPR issue, take Type 1 DMRS as an example, when ports 0,2 are used together the sequences in frequency domain as shown in FIG. 10. With sᵢ(n) denoting time domain signal from CDM group i, in an event that two CDM group signals are the same but d subcarriers apart in frequency domain, then

$${s}_{i + 1} ( n ) = {e}^{j \frac{2 π d}{N}} {s}_{i} ( n ) ,$$

with N being Fast Fourier Transform (FFT) size. With D CDM groups present, the overall time domain signal (assuming equal weight) would be as follows:

$$\begin{matrix}{\sum }_{i = 0}^{D} {s}_{i } ( n ) = ( 1 + {e}^{j \frac{2 π nd}{N}} + {e}^{j \frac{4 π nd}{N}} + … + {e}^{j \frac{2 π nd ( D - 1 )}{N}} ) {s}_{0} ( n ) \\ = ( \frac{1 - {e}^{j \frac{2 π ndD}{N}}}{1 - {e}^{j \frac{2 π nd}{N}}} ) {s}_{0} ( n ) \\ = {f}_{d , B} ( n ) {s}_{0} ( n )\end{matrix}$$

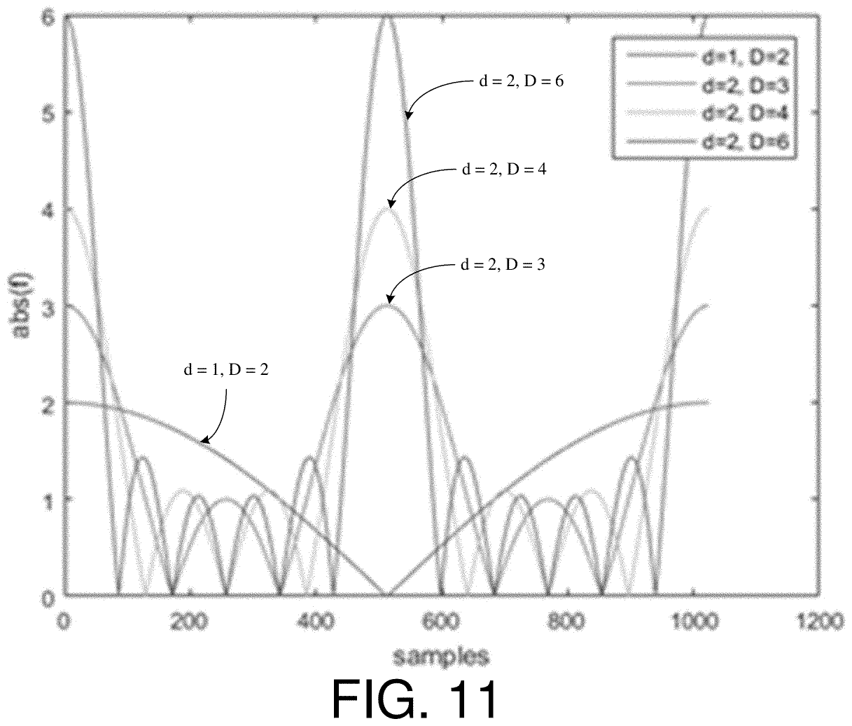

In the case of Type 1 DMRS (e.g., as shown in FIG. 10), d=1 and D≤2. For Type 2 DMRS, d=2 and D≤3. FIG. 11 shows |f_{d, D}(n)| for some value pair (d, D) of interest. It can be observed that the combined time domain signal can be with four times peak power as the original single group for Type 1 and nine times for Type 2 configuration.

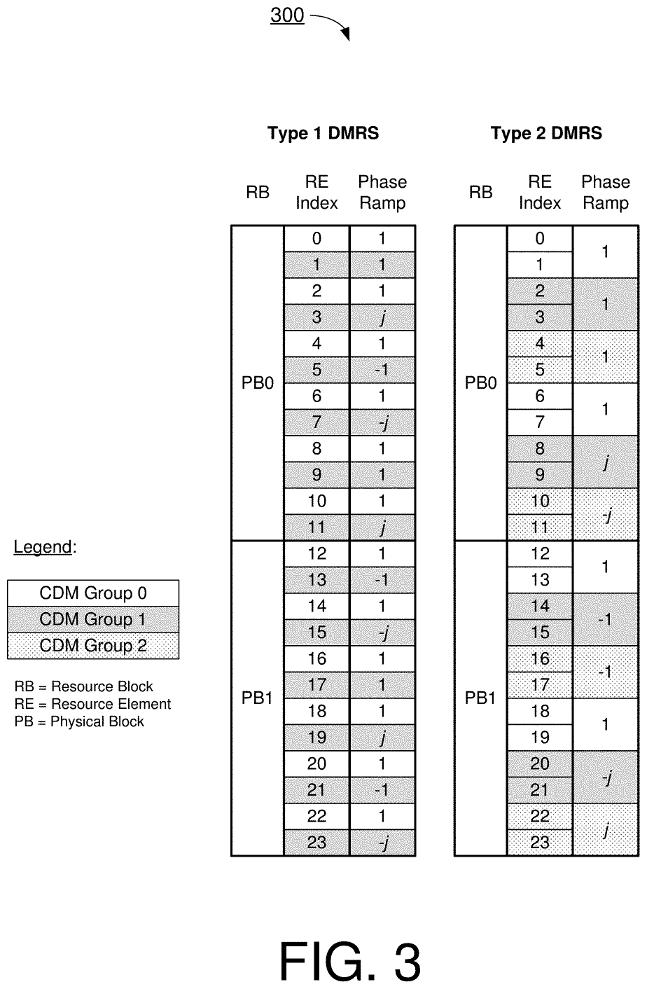

In view of the above, the present disclosure aims to address the high PAPR issue with various proposed schemes, as described below. FIG. 3 illustrates an example scenario 300 in accordance with an implementation of the present disclosure. The following description of proposed schemes with respect to the power imbalance issue is provided with reference to FIG. 3.

Under the various proposed schemes in accordance with the present disclosure, a general concept is to resolve high PAPR, caused by signals from multiple CDM groups, may be modify sᵢ (n) by some means. In each of the various proposed schemes described below, sequences used in each CDM group is manipulated in a certain way to avoid high PAPR. In the following description, r(k) denotes the base Gold sequence and rᵢ(k) denotes the frequency-domain sequence used for CDM group i. Here sᵢ(n), denotes the corresponding time-domain waveform of group i.

In one proposed scheme in accordance with the present disclosure, a group-specific sequence shift may be applied to or otherwise performed on a respective frequency-domain sequence of each CDM group. That is, different Gold sequences may be used for each CDM group. Under this proposed scheme, different sequence offset Kᵢ may be used for CDM group i. For instance, r₀(k)=r(k+K₀), r₁(k)=r(k+K₁).

In another proposed scheme in accordance with the present disclosure, a group-specific phase ramp may be applied to or otherwise performed on a respective frequency-domain sequence of each CDM group. That is, a group-specific phase ramp may be applied to r(k). An example shown in FIG. 3 applies phase ramp with step

$${e}^{j \frac{π {d}_{i}}{2}}$$

to CDM group i, where dᵢ is in accordance with Table 3 below. It is noteworthy that, in this proposed scheme, time domain s₁(n) is a circular shifted and modulated version of s₀(n).

TABLE 3
Group-Specific Phase Ramp Parameters

| CDM Group i | dᵢ |
|---|---|
| 0 | 0 |
| 1 | 1 |
| 2 | 3 |

In yet another proposed scheme in accordance with the present disclosure, a group-specific sequence permutation may be applied to or otherwise performed on the respective frequency-domain sequence of each CDM group. That is, sequence r(k) may be permuted according to a group-specific permutation function πᵢ. In other words, rᵢ(k)=r(πᵢ(k)) . One option for permutation function may be reverse order, by which a time-domain signal may also be reversed. Another option for permutation function may be to sequentially pick all even samples and then all odd samples, or vice versa.

In still another proposed scheme in accordance with the present disclosure, a respective sequence of each CDM group may be initialized with a group-specific initial seed which may be related to a respective CDM group index. Detailed description pertaining to this proposed scheme is provided below.

To avoid high PAPR, a working assumption for Type 1 DMRS is that the two cᵢₙᵢₜ (configured by n_{SCID}=0,1, respectively) in Rel-15 are used for port(s) in each of the two groups, respectively. Here, cᵢₙᵢₜ (n_{SCID}=k) denotes the value of cᵢₙᵢₜ in TS 38.211 formula when n_{SCID} is set to k. It is noteworthy that n_{SCID} was intended for other purpose(s). For example, one use case of n_{SCID} is to support dynamic point selection (DPS). Thus, instead of a fix scheme that CDM group k uses cᵢₙᵢₜ (n_{SCID}=k), k=0,1, the parameter n_{SCID} may be toggled in the formula according to the DCI field as shown in Table 4 below. DCI is the one-bit “DMRS sequence initialization” field in DCI format 0_1/1_1

TABLE 4
Setting of cᵢₙᵢₜ for CDM Group and DCI

| CDM Group | DCI = 0 | DCI = 1 |
|---|---|---|
| 0 | cᵢₙᵢₜ (n_{SCID} = 0) | cᵢₙᵢₜ (n_{SCID} = 1) |
| 1 | cᵢₙᵢₜ (n_{SCID} = 1) | cᵢₙᵢₜ (n_{SCID} = 0) |

In this way, a user equipment (UE) in compliance with release 16 (Rel-16) of the 3GPP specification may use different cᵢₙᵢₜ for each CDM group, thereby achieving low PAPR. Moreover, a UE in compliance with Rel-15 may be co-scheduled in either CDM group with proper setting of n_{SCID} (DCI controlled), assuming ports are within one CDM group.

For cyclic-prefix OFDM (CP-OFDM) Type 2 DMRS, there are three CDM groups and, thus, solutions based on one-bit n_{SCID} cannot work. To come up with a group-dependent cᵢₙᵢₜ value, the following factors may be considered: backward compatibility and cross-correlation property. With respect to backward compatibility, when co-scheduling Rel-15 UEs and Rel-16 UEs in a multi-user (MU) scenario in the same CDM group, the orthogonality may be retained between DMRS ports. Additionally, the maximum number of CDM groups may be co-scheduled with Rel-15 UEs. With respect to cross-correlation property, the modified cᵢₙᵢₜ may have a similar (partial) cross-correlation property as in Rel-15. Backward compatibility concern may greatly reduce the possible form of a new formula. Therefore, the Rel-15 cᵢₙᵢₜ formula should be extended in a way that Rel-15 cᵢₙᵢₜ is a special case when some parameters are fixed to constants.

In view of the above, a possible approach is expressed mathematically as follows:

f(x, y)≡(2¹⁷⁽N_{symb}^{slot}n_{s,f}^{μ}+l+1)+(2N_{1D}^{x}+1)+2N_{1D}^{x}+y)mod2³¹, x, y ∈{0,1} cᵢₙᵢₜ^{r15}=f(n_{SCID}, n_{SCID}) cᵢₙᵢₜ^{r16}(λₚ)=f(n_{SCID}⊕λₚ[0], n_{SCID}⊕λₚ[0]⊕λₚ[1])

Here, cᵢₙᵢₜ^{r15} and cᵢₙᵢₜ^{r16} denote the sequence initialization for Rel-15 and Rel-16, respectively. Moreover, λₚ is a two-bit value of CDM group index for the associated port p and is in {0,1} for Type 1 and in {0,1,2} for Type 2. Furthermore, operator ⊕ is bitwise XOR, and x[i:j] stands for bits from location i to j where index 0 is least-significant bit (LSB). It can be checked that, for CDM group 0 and group 1, cᵢₙᵢₜ^{r15}=cᵢₙᵢₜ^{r16} may be obtained by properly setting n_{SCID} for Rel-15 UEs, assuming those UEs use ports within one CDM group. Additionally, this is consistent with Table 4 so the two types can be stated in a unified way. In short, under this proposed scheme, for physical downlink shared channel (PDSCH) and physical uplink shared channel (PUSCH), the value of cᵢₙᵢₜ may be derived based on CDM group index for both Type 1 DMRS and Type 2 DMRS.

### Illustrative Implementations

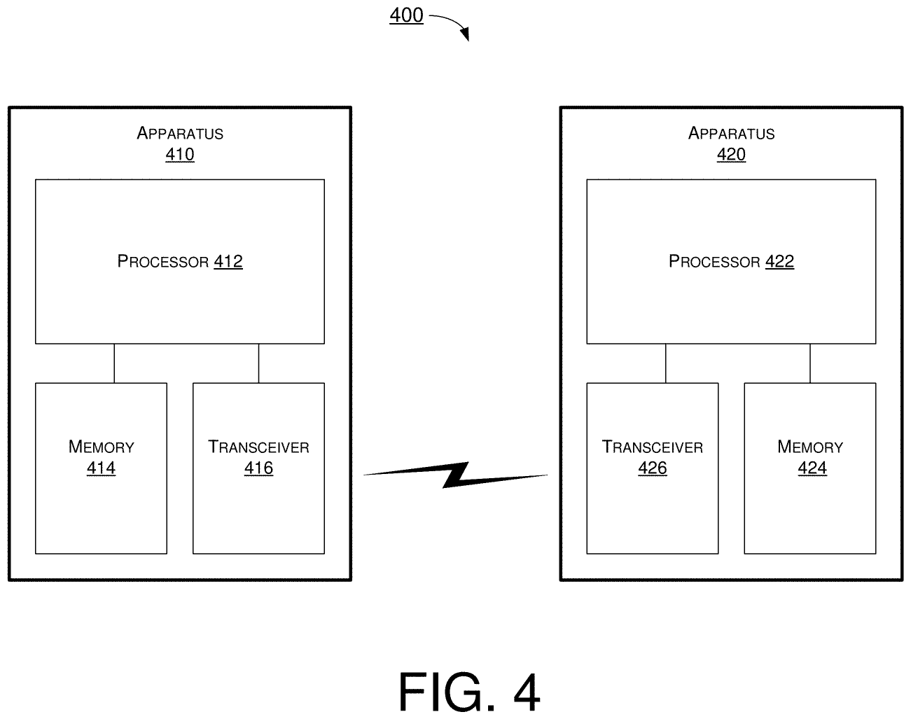

FIG. 4 illustrates an example communication environment 400 having an example apparatus 410 and an example apparatus 420 in accordance with an implementation of the present disclosure. Each of apparatus 410 and apparatus 420 may perform various functions to implement schemes, techniques, processes and methods described herein pertaining to reference signals with low power imbalance and low PAPR in mobile communications, including various schemes described above as well as processes 500, 600 and 700 described below.

Each of apparatus 410 and apparatus 420 may be a part of an electronic apparatus, which may be a UE such as a portable or mobile apparatus, a wearable apparatus, a wireless communication apparatus or a computing apparatus. For instance, each of apparatus 410 and apparatus 420 may be implemented in a smartphone, a smartwatch, a personal digital assistant, a digital camera, or a computing equipment such as a tablet computer, a laptop computer or a notebook computer. Alternatively, each of apparatus 410 and apparatus 420 may be a part of a machine type apparatus, which may be an IoT or NB-IoT apparatus such as an immobile or a stationary apparatus, a home apparatus, a wire communication apparatus or a computing apparatus. For instance, each of apparatus 410 and apparatus 420 may be implemented in a smart thermostat, a smart fridge, a smart door lock, a wireless speaker or a home control center.

In some implementations, each of apparatus 410 and apparatus 420 may be implemented in the form of one or more integrated-circuit (IC) chips such as, for example and without limitation, one or more single-core processors, one or more multi-core processors, or one or more complex-instruction-set-computing (CISC) processors. Each of apparatus 410 and apparatus 420 may include at least some of those components shown in FIG. 4 such as a processor 412 and a processor 422, respectively. Each of apparatus 410 and apparatus 420 may further include one or more other components not pertinent to the proposed scheme of the present disclosure (e.g., internal power supply, display device and/or user interface device), and, thus, such component(s) of each of apparatus 410 and apparatus 420 are neither shown in FIG. 4 nor described below in the interest of simplicity and brevity.

In some implementations, at least one of apparatus 410 and apparatus 420 may be a part of an electronic apparatus, which may be a network node or base station (e.g., eNB, gNB or transmit/receive point (TRP)), a small cell, a router or a gateway. For instance, at least one of apparatus 410 and apparatus 420 may be implemented in an eNodeB in an LTE, LTE-Advanced or LTE-Advanced Pro network or in a gNB in a 5G, NR, IoT or NB-IoT network. Alternatively, at least one of apparatus 410 and apparatus 420 may be implemented in the form of one or more IC chips such as, for example and without limitation, one or more single-core processors, one or more multi-core processors, or one or more CISC processors.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including reference signals with low power imbalance and low PAPR in mobile communications in accordance with various implementations of the present disclosure.

In some implementations, apparatus 410 may also include a transceiver 416, as a communication device, coupled to processor 412 and capable of wirelessly transmitting and receiving data for MU-MIMO and SU-MIMO. In some implementations, apparatus 410 may further include a memory 414 coupled to processor 412 and capable of being accessed by processor 412 and storing data therein. In some implementations, apparatus 420 may also include a transceiver 426, as a communication device, coupled to processor 422 and capable of wirelessly transmitting and receiving data for MU-MIMO and SU-MIMO. In some implementations, apparatus 420 may further include a memory 424 coupled to processor 422 and capable of being accessed by processor 422 and storing data therein. Accordingly, apparatus 410 and apparatus 420 may wirelessly communicate with each other via transceiver 416 and transceiver 426, respectively.

To aid better understanding, the following description of the operations, functionalities and capabilities of each of apparatus 410 and apparatus 420 is provided in the context of an NR communication environment in which apparatus 410 is implemented in or as a wireless communication device, a communication apparatus or a UE and apparatus 420 is implemented in or as a base station (e.g., eNB, gNB or TRP) connected or otherwise communicatively coupled to a wireless network (e.g., 5G/NR mobile network).

In one aspect of reference signals with low power imbalance and low PAPR in mobile communications in accordance with the present disclosure, processor 412 of apparatus 410, as a UE, may generate a multi-port multi-symbol RS. For instance, processor 412 may perform either or both of: (1) modifying a time-domain orthogonal cover code (TD-OCC) pattern for CDM with respect to the multi-port multi-symbol RS such that time-domain power imbalance is reduced, and (2) performing a permutation on a respective sequence of each CDM group of a plurality of CDM groups with respect to the multi-port multi-symbol RS such that a PAPR is reduced. Moreover, processor 412 may control a transmitter of transceiver 416 to transmit the multi-port multi-symbol RS to apparatus 420 through a plurality of antenna ports.

In some implementations, in modifying the TD-OCC pattern, processor 412 may perform a circular shift on the TD-OCC pattern. Alternatively, in modifying the TD-OCC pattern, processor 412 may perform a port-specific phase rotation on the TD-OCC pattern. Still alternatively, in modifying the TD-OCC pattern, processor 412 may perform both a port-specific phase rotation and a circular shift on the TD-OCC pattern.

In some implementations, in performing the permutation on the respective sequence of each CDM group, processor 412 may apply a group-specific sequence shift to a respective frequency-domain sequence of each CDM group. Alternatively, in performing the permutation on the respective sequence of each CDM group, processor 412 may apply a group-specific phase ramp to a respective frequency-domain sequence of each CDM group. Alternatively, in performing the permutation on the respective sequence of each CDM group, processor 412 may apply a group-specific sequence permutation to a respective frequency-domain sequence of each CDM group. Still alternatively, in performing the permutation on the respective sequence of each CDM group, processor 412 may initialize the respective sequence of each CDM group with a group-specific initial seed. For instance, for each CDM group, the group-specific initial seed may be related to a respective CDM group index.

In some implementations, the multi-port multi-symbol RS may include a DMRS. Alternatively, the multi-port multi-symbol RS may include a CSI-RS.

In another aspect of reference signals with low power imbalance and low PAPR in mobile communications in accordance with the present disclosure, processor 422 of apparatus 420, as a base station, may generate a multi-port multi-symbol RS. For instance, processor 422 may perform either or both of: (1) modifying a TD-OCC pattern for CDM with respect to the multi-port multi-symbol RS such that time-domain power imbalance is reduced, and (2) performing a permutation on a respective sequence of each CDM group of a plurality of CDM groups with respect to the multi-port multi-symbol RS such that a PAPR is reduced. Moreover, processor 422 may control a transmitter of transceiver 426 to transmit the multi-port multi-symbol RS to apparatus 410 through a plurality of antenna ports.

In some implementations, in modifying the TD-OCC pattern, processor 422 may perform a circular shift on the TD-OCC pattern. Alternatively, in modifying the TD-OCC pattern, processor 422 may perform a port-specific phase rotation on the TD-OCC pattern. Still alternatively, in modifying the TD-OCC pattern, processor 422 may perform both a port-specific phase rotation and a circular shift on the TD-OCC pattern.

In some implementations, in performing the permutation on the respective sequence of each CDM group, processor 422 may apply a group-specific sequence shift to a respective frequency-domain sequence of each CDM group. Alternatively, in performing the permutation on the respective sequence of each CDM group, processor 422 may apply a group-specific phase ramp to a respective frequency-domain sequence of each CDM group. Alternatively, in performing the permutation on the respective sequence of each CDM group, processor 422 may apply a group-specific sequence permutation to a respective frequency-domain sequence of each CDM group. Still alternatively, in performing the permutation on the respective sequence of each CDM group, processor 422 may initialize the respective sequence of each CDM group with a group-specific initial seed. For instance, for each CDM group, the group-specific initial seed may be related to a respective CDM group index.

In some implementations, the multi-port multi-symbol RS may include a DMRS. Alternatively, the multi-port multi-symbol RS may include a CSI-RS.

### Illustrative Processes

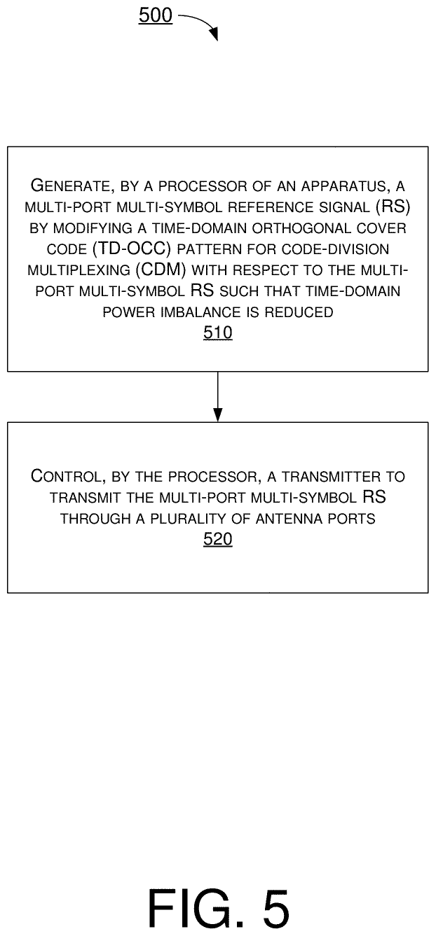

FIG. 5 illustrates an example process 500 in accordance with an implementation of the present disclosure. Process 500 may be an example implementation of the proposed schemes described above with respect to reference signals with low power imbalance and low PAPR in mobile communications in accordance with the present disclosure. Process 500 may represent an aspect of implementation of features of apparatus 410 and apparatus 420. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may also be repeated partially or entirely. Process 500 may be implemented by apparatus 410, apparatus 420 and/or any suitable wireless communication device, UE, base station or machine type devices. Solely for illustrative purposes and without limitation, process 500 is described below in the context of apparatus 410 as a UE and apparatus 420 as a base station of a wireless network (e.g., 5G/NR mobile network). Process 500 may begin at block 510.

At 510, process 500 may involve processor 412 of apparatus 410 as a UE generating a multi-port multi-symbol reference signal (RS). For instance, process 500 may involve processor 412 modifying a time-domain orthogonal cover code (TD-OCC) pattern for CDM with respect to the multi-port multi-symbol RS such that time-domain power imbalance is reduced. Process 500 may proceed from 510 to 520.

At 520, process 500 may involve processor 412 controlling a transmitter of transceiver 416 to transmit the multi-port multi-symbol RS to apparatus 420 through a plurality of antenna ports.

In some implementations, in modifying the TD-OCC pattern, process 500 may involve processor 412 performing a circular shift on the TD-OCC pattern. Alternatively, in modifying the TD-OCC pattern, process 500 may involve processor 412 performing a port-specific phase rotation on the TD-OCC pattern. Still alternatively, in modifying the TD-OCC pattern, process 500 may involve processor 412 performing both a port-specific phase rotation and a circular shift on the TD-OCC pattern.

In some implementations, the multi-port multi-symbol RS may include a DMRS. Alternatively, the multi-port multi-symbol RS may include a CSI-RS.

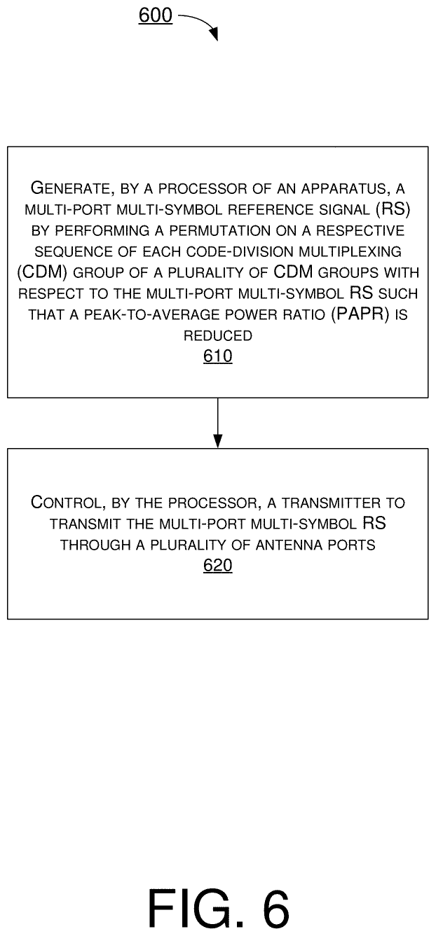

FIG. 6 illustrates an example process 600 in accordance with an implementation of the present disclosure. Process 600 may be an example implementation of the proposed schemes described above with respect to reference signals with low power imbalance and low PAPR in mobile communications in accordance with the present disclosure. Process 600 may represent an aspect of implementation of features of apparatus 410 and apparatus 420. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks of process 600 may executed in the order shown in FIG. 6 or, alternatively, in a different order. Process 600 may also be repeated partially or entirely. Process 600 may be implemented by apparatus 410, apparatus 420 and/or any suitable wireless communication device, UE, base station or machine type devices. Solely for illustrative purposes and without limitation, process 600 is described below in the context of apparatus 410 as a UE and apparatus 420 as a base station of a wireless network (e.g., 5G/NR mobile network). Process 600 may begin at block 610.

At 610, process 600 may involve processor 412 of apparatus 410 as a UE generating a multi-port multi-symbol RS. For instance, process 600 may involve processor 412 performing a permutation on a respective sequence of each CDM group of a plurality of CDM groups with respect to the multi-port multi-symbol RS such that a PAPR is reduced. Process 600 may proceed from 610 to 620.

At 620, process 600 may involve processor 412 controlling a transmitter of transceiver 416 to transmit the multi-port multi-symbol RS to apparatus 420 through a plurality of antenna ports.

In some implementations, in performing the permutation on the respective sequence of each CDM group, process 600 may involve processor 412 applying a group-specific sequence shift to a respective frequency-domain sequence of each CDM group. Alternatively, in performing the permutation on the respective sequence of each CDM group, process 600 may involve processor 412 applying a group-specific phase ramp to a respective frequency-domain sequence of each CDM group. Alternatively, in performing the permutation on the respective sequence of each CDM group, process 600 may involve processor 412 applying a group-specific sequence permutation to a respective frequency-domain sequence of each CDM group. Still alternatively, in performing the permutation on the respective sequence of each CDM group, process 600 may involve processor 412 initializing the respective sequence of each CDM group with a group-specific initial seed. For instance, for each CDM group, the group-specific initial seed may be related to a respective CDM group index.

In some implementations, the multi-port multi-symbol RS may include a DMRS. Alternatively, the multi-port multi-symbol RS may include a CSI-RS.

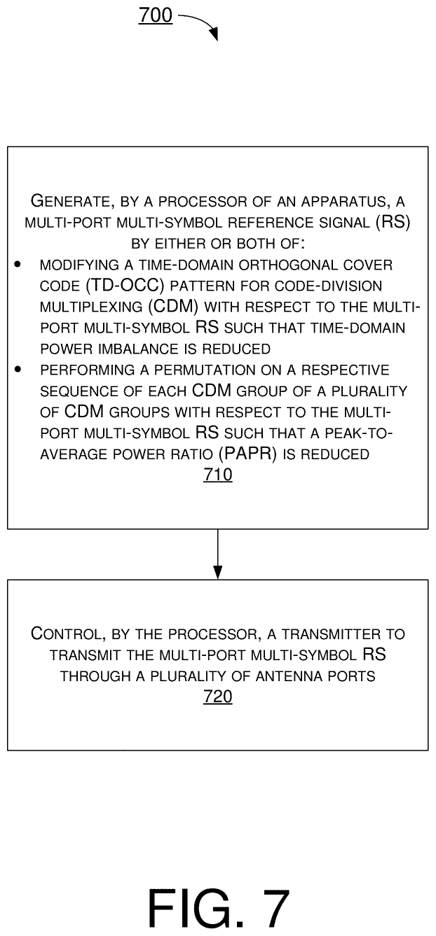

FIG. 7 illustrates an example process 700 in accordance with an implementation of the present disclosure. Process 700 may be an example implementation of the proposed schemes described above with respect to reference signals with low power imbalance and low PAPR in mobile communications in accordance with the present disclosure. Process 700 may represent an aspect of implementation of features of apparatus 410 and apparatus 420. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks of process 700 may executed in the order shown in FIG. 7 or, alternatively, in a different order. Process 700 may also be repeated partially or entirely. Process 700 may be implemented by apparatus 410, apparatus 420 and/or any suitable wireless communication device, UE, base station or machine type devices. Solely for illustrative purposes and without limitation, process 700 is described below in the context of apparatus 410 as a UE and apparatus 420 as a base station of a wireless network (e.g., 5G/NR mobile network). Process 700 may begin at block 710.

At 710, process 700 may involve processor 412 of apparatus 410 as a UE generating a multi-port multi-symbol RS. For instance, process 700 may involve processor 412 performing either or both of: (1) modifying a TD-OCC pattern for CDM with respect to the multi-port multi-symbol RS such that time-domain power imbalance is reduced, and (2) performing a permutation on a respective sequence of each CDM group of a plurality of CDM groups with respect to the multi-port multi-symbol RS such that a PAPR is reduced. Process 700 may proceed from 710 to 720.

At 720, process 700 may involve processor 412 controlling a transmitter of transceiver 416 to transmit the multi-port multi-symbol RS to apparatus 420 through a plurality of antenna ports.

In some implementations, in modifying the TD-OCC pattern, process 700 may involve processor 412 performing a circular shift on the TD-OCC pattern. Alternatively, in modifying the TD-OCC pattern, process 700 may involve processor 412 performing a port-specific phase rotation on the TD-OCC pattern. Still alternatively, in modifying the TD-OCC pattern, process 700 may involve processor 412 performing both a port-specific phase rotation and a circular shift on the TD-OCC pattern.

In some implementations, in performing the permutation on the respective sequence of each CDM group, process 700 may involve processor 412 applying a group-specific sequence shift to a respective frequency-domain sequence of each CDM group. Alternatively, in performing the permutation on the respective sequence of each CDM group, process 700 may involve processor 412 applying a group-specific phase ramp to a respective frequency-domain sequence of each CDM group. Alternatively, in performing the permutation on the respective sequence of each CDM group, process 700 may involve processor 412 applying a group-specific sequence permutation to a respective frequency-domain sequence of each CDM group. Still alternatively, in performing the permutation on the respective sequence of each CDM group, process 700 may involve processor 412 initializing the respective sequence of each CDM group with a group-specific initial seed. For instance, for each CDM group, the group-specific initial seed may be related to a respective CDM group index.

In some implementations, the multi-port multi-symbol RS may include a DMRS. Alternatively, the multi-port multi-symbol RS may include a CSI-RS.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating, by a processor of an apparatus, a multi-port multi-symbol reference signal (RS); and
controlling, by the processor, a transmitter to transmit the multi-port multi-symbol RS through a plurality of antenna ports,
wherein the generating of the multi-port multi-symbol RS comprises modifying a time-domain orthogonal cover code (TD-OCC) pattern for code-division multiplexing (CDM) with respect to the multi-port multi-symbol RS such that time-domain power imbalance is reduced.

2. The method of claim 1, wherein the modifying of the TD-OCC pattern comprises performing a circular shift on the TD-OCC pattern.

3. The method of claim 1, wherein the modifying of the TD-OCC pattern comprises performing a port-specific phase rotation on the TD-OCC pattern.

4. The method of claim 1, wherein the modifying of the TD-OCC pattern comprises performing both a port-specific phase rotation and a circular shift on the TD-OCC pattern.

5. The method of claim 1, wherein the multi-port multi-symbol RS comprises a demodulation reference signal (DMRS).

6. The method of claim 1, wherein the multi-port multi-symbol RS comprises a channel state information reference signal (CSI-RS).

7. A method, comprising:
generating, by a processor of an apparatus, a multi-port multi-symbol reference signal (RS); and
controlling, by the processor, a transmitter to transmit the multi-port multi-symbol RS through a plurality of antenna ports,
wherein the generating of the multi-port multi-symbol RS comprises performing a permutation on a respective sequence of each code-division multiplexing (CDM) group of a plurality of CDM groups with respect to the multi-port multi-symbol RS such that a peak-to-average power ratio (PAPR) is reduced.

8. The method of claim 7, wherein the performing of the permutation on the respective sequence of each CDM group comprises applying a group-specific sequence shift to a respective frequency-domain sequence of each CDM group.

9. The method of claim 7, wherein the performing of the permutation on the respective sequence of each CDM group comprises applying a group-specific phase ramp to a respective frequency-domain sequence of each CDM group.

10. The method of claim 7, wherein the performing of the permutation on the respective sequence of each CDM group comprises applying a group-specific sequence permutation to a respective frequency-domain sequence of each CDM group.

11. The method of claim 7, wherein the performing of the permutation on the respective sequence of each CDM group comprises initializing the respective sequence of each CDM group with a group-specific initial seed.

12. The method of claim 11, wherein, for each CDM group, the group-specific initial seed is related to a respective CDM group index.

13. The method of claim 7, wherein the multi-port multi-symbol RS comprises a demodulation reference signal (DMRS).

14. The method of claim 7, wherein the multi-port multi-symbol RS comprises a channel state information reference signal (CSI-RS).

15. A method, comprising:
generating, by a processor of an apparatus, a multi-port multi-symbol reference signal (RS); and
controlling, by the processor, a transmitter to transmit the multi-port multi-symbol RS through a plurality of antenna ports,
wherein the generating of the multi-port multi-symbol RS comprises either or both of:
modifying a time-domain orthogonal cover code (TD-OCC) pattern for code-division multiplexing (CDM) with respect to the multi-port multi-symbol RS such that time-domain power imbalance is reduced; and
performing a permutation on a respective sequence of each CDM group of a plurality of CDM groups with respect to the multi-port multi-symbol RS such that a peak-to-average power ratio (PAPR) is reduced.

16. The method of claim 15, wherein the modifying of the TD-OCC pattern comprises one of:
performing a circular shift on the TD-OCC pattern;
performing a port-specific phase rotation on the TD-OCC pattern; and
performing both the port-specific phase rotation and the circular shift on the TD-OCC pattern.

17. The method of claim 15, wherein the performing of the permutation on the respective sequence of each CDM group comprises one of:
applying a group-specific sequence shift to a respective frequency-domain sequence of each CDM group;
applying a group-specific phase ramp to the respective frequency-domain sequence of each CDM group;
applying a group-specific sequence permutation to the respective frequency-domain sequence of each CDM group; and
initializing the respective sequence of each CDM group with a group-specific initial seed.

18. The method of claim 17, wherein, for each CDM group, the group-specific initial seed is related to a respective CDM group index.

19. The method of claim 15, wherein the multi-port multi-symbol RS comprises a demodulation reference signal (DMRS).

20. The method of claim 15, wherein the multi-port multi-symbol RS comprises a channel state information reference signal (CSI-RS).
